(19) United States
(12) Patent Application Publication
(10) Pub. No.: US 2010/0021670 A1
(43) Pub. Date: Jan. 28, 2010

(54) Self adhering fabric patch and moisture resistant flexible enclosure for containing the patch

(75) Inventor: Mark Llano, Wellington, FL (US)

Correspondence Address: ROBERT M. DOWNEY, P.A., 6751 N. FEDERAL HWY., SUITE 300, BOCA RATON, FL, 33487, US

(73) Assignee: Mark Llano (51%) & Randall Webb (49%)

(21) Appl. No.: 12/316,814

(22) Filed: Dec. 17, 2008

Related U.S. Application Data
(63) Continuation-in-part of application No. 12/074,623, filed on Mar. 4, 2008.

(51) Int. Cl. B32B 27/34; B32B 43/00

(52) U.S. Cl. 428/41.7; 428/40.1; 428/63

(57) ABSTRACT

A flame retardant patch for repairing a tear or hole in clothing or gear includes a flame resistant fabric and a pressure sensitive adhesive bonded to the fabric by hot melt lamination. The pressure sensitive adhesive contains halogenated flame retardant compounds. A release paper covers the pressure sensitive adhesive and is removed to allow application of the flame retardant patch to the clothing or other item being repaired. The patch is attached by applying pressure to the top fabric surface of the patch for approximately 45 seconds using the convex surface of a spoon-like object. The patch is contained in a flexible moisture resistant enclosure formed of a thermoplastic urethane composition.

This application is a Continuation-In-Part application of co-pending U.S. patent application Ser. No. 12/074,623 filed on Mar. 4, 2008.

### BACKGROUND OF THE INVENTION

1. Field of the Invention

The present invention is directed to a self-adhering fabric patch for repairing clothing, and more particularly, to a self-adhering flame retardant patch contained in a moisture resistant flexible enclosure for quickly repairing tears or openings in clothing and gear such as, but not limited to, military combat uniforms, backpacks, camouflage helmet covers and other fabric articles, without the use of a hot iron or a thread and needle.

2. Discussion of the Related Art

Flame resistant materials are commonly used in the manufacture of military uniforms, and particularly combat uniforms, as well as firefighter gear, driving suits and gloves for race car drivers and astronaut suits. Obviously, use of flame resistant fabric materials for these various garments is for the purpose of protecting the wearer from burn injuries as a result of exposure to flames or extreme temperatures. The fire resistant material, typically made from aromatic polyamide fibers, provides a barrier of protection between the wearer's skin and flames from a fire or explosion. However, even a small hole or tear in the fire resistant fabric can compromise the burn protection property of the garment and expose the wearer to serious injury. In the event a direct flame finds its way through a hole or tear in the fire resistant garment, the wearer's undergarments can ignite and cause severe burns and possible fatal injury. Accordingly, it is important to repair all tears and openings in fire protective garments in a manner that completely closes these openings to restore the flame resistant integrity of the garment.

The repair of tears and openings is particularly problematic for soldiers wearing military combat uniforms. These soldier uniforms and various items of equipment (e.g. backpacks), usually made of a camouflage fabric such as NOMEX®, NYCO™, DEFENDER-M™, APECS Nylon outerwear, and ECWCS GORE-TEX®/CORDURA® gear are susceptible to tearing and seat and seam failures as a result of the harsh conditions a soldier is exposed to in combat and training operations. In the event a soldier wears a hole or gets a tear in the camouflage uniform or gear, it is extremely important to repair the opening as soon as possible. A tear in the uniform or gear could compromise the camouflage and render the soldier visible to the enemy. And, if the soldier's uniform is flame resistant (e.g. NOMEX®) it is important to close tears or openings in order to preserve the flame resistant integrity of the uniform. Due to the continuous threat of exposure to flames, such as from an improvised explosive device (IED), it is preferable to repair holes as tears in a soldier's uniform while out in the field. Presently, the only available method for soldiers to repair tears and openings in the flame resistant camouflage uniform is with the use of a needle and thread. However, this method of closing a tear or opening is not sufficient to provide full protection. Sewing an opening closed, particularly out in the field, does not restore the complete flame resistant integrity of the uniform. Accordingly, there remains an urgent need for a repair kit that allows a soldier to quickly and easily repair tears and openings in their uniforms and gear. Moreover, there remains a need for a moisture resistant flexible enclosure for containing a retardant self-adhering fabric patch that can be carried in a soldier's gear or uniform for making quick repairs to holes or tears in a soldier's uniform while in the filed of combat.

### OBJECTS AND ADVANTAGES OF THE INVENTION

Considering the foregoing, it is a primary object of the present invention to provide a patch for repairing tears and openings in garments without the use of stitching, and wherein the repair patch includes a pressure sensitive adhesive that allows the patch to be fully bonded to the garment in approximately 45 seconds.

It is a further object of the present invention to provide a repair patch that includes a fabric layer that matches the garment being repaired, and further wherein the patch includes a pressure sensitive adhesive laminated to a bottom side of the fabric to enable easy application and attachment of the patch to a garment in order to fully cover a tear or opening in the garment.

It is still a further object of the present invention to provide a repair patch that is particularly suited for repairing tears and holes in soldier uniforms and equipment, and wherein the patch includes a fabric with a digitally printed camouflage pattern that matches the camouflage pattern of the soldier uniform and equipment, and further wherein the patch is flame retardant.

It is still a further object of the present invention to provide a soldier uniform repair patch that quickly and easily attaches to the soldier uniform by applying pressure, such as with the use of a spoon-like object, in approximately 45 seconds and without the use of a needle and thread, and further wherein the patch is contained in a moisture resistant flexible enclosure that can be sewn into the soldier's uniform or carried in a soldier's gear pack.

It is still a further object of the present invention to provide a soldier uniform repair patch and moisture resistant enclosure that meet or exceed the flame retardant and near infra red (NIR) compliance standards of the soldier uniform material.

It is yet a further object of the present invention to provide a moisture resistant flexible enclosure for containing the flame retardant patch, and wherein the flexible enclosure is formed of a thermoplastic polymer that is easily heat sealed with maximum sealing characteristics and no voiding.

It is still a further object of the present invention to provide a moisture resistant flexible enclosure for containing the flame retardant patch, and wherein the enclosure is formed of a thermoplastic polymer that can be easily heat sealed and resealed multiple times without sacrificing the inherent properties of the thermoplastic polymer material.

It is still a further object of the present invention to provide a moisture resistant enclosure for containing the flame retardant patch, and wherein the enclosure is formed of a polymer material that has superior flexibility characteristics for ease of physical manipulation, even at temperatures below minus 40 degrees Fahrenheit.

It is still a further object of the present invention to provide a moisture resistant enclosure for containing the flame retardant patch, and wherein the enclosure material has flame retardant properties.

It is yet a further object of the present invention to provide a moisture resistant flexible enclosure for containing the flame retardant patch, and wherein the enclosure is designed for unique applications requiring the highest moisture resistance, chemical stability, and insulation properties.

It is still a further object of the present invention to provide a flexible enclosure for containing the flame retardant patch, and wherein the enclosure is formed of a polymer material having maximum moisture and chemical resistance beyond 200 degrees Fahrenheit.

It is still a further object of the present invention to provide a moisture resistant flexible enclosure for containing the flame retardant patch, and wherein the enclosure is formed of a polymer material characterized by very uniform molecular distribution and linear structure insuring maximum hydrophobic properties and nil sound when manipulated for optimal acoustical dampening and a soft feel texture for maximum comfort when carried in an article of clothing, such as a soldier's uniform.

It is still a further object of the present invention to provide a flexible moisture resistant enclosure for containing the flame retardant patch, and wherein the enclosure is inherently anti-static.

### SUMMARY OF THE INVENTION

The present invention is directed to a flame retardant patch for repairing a tear or hole in clothing and gear that is contained in a moisture resistant flexible enclosure. The patch includes a flame resistant fabric made from aromatic polyamide fibers, and a pressure sensitive adhesive bonded to the fabric by hot melt lamination. The pressure sensitive adhesive contains halogenated flame retardant compounds. A release paper covers the pressure sensitive adhesive and is removed to allow application of the patch to the clothing item being repaired. The patch is attached to clothing and gear by applying pressure to the top fabric surface of the patch, pressing firmly to smooth out wrinkles, creases and air pockets, and then rubbing with consistent pressure for approximately 45 seconds, using the convex surface of a spoon-like object, to push the adhesive into the pores of the fabric of the clothing or gear while generating heat to accelerate the adhesion process. In a preferred embodiment, the patch is used for repairing soldier combat uniforms and gear made of camouflage material such as NYCO Twills and Ripstop, Defender-M™, Nomex®, APECS Nylon outerwear, and ECWCS GORE-TEX®/CORDURA® gear. The flame resistant fabric of the patch is digitally printed with a camouflage pattern that matches the soldier uniform and/or gear camouflage pattern. The patch meets or exceeds the flame retardant and NIR compliance standards of soldier combat uniforms.

The flame resistant patch is contained within a moisture resistant flexible enclosure that can be sewn into the soldier's combat uniform or carried in a pocket or gear pack. In a preferred embodiment, the flexible enclosure is formed of a thermoplastic urethane material having excellent chemical resistance, a low moisture vapor transmission rate, high strength and flexibility and nil sound when manipulated. The flexible enclosure is heat sealed around the peripheral edges to provide a moisture resistant interior environment for containing the patch.

### BRIEF DESCRIPTION OF THE DRAWINGS

For a fuller understanding of the nature of the present invention, reference should be made to the following detailed description taken in conjunction with the accompanying drawings in which:

FIG. 1 is an isolated view of a sleeve of a camouflage uniform on the arm of a soldier, shown with a tear in the material of the uniform;

FIG. 2 is an isolated perspective view demonstrating the manner of repairing the tear shown in FIG. 1, by first closing the tear using the fingers;

FIG. 3 is a perspective view showing the uniform repair patch of the present invention, and particularly a protective backing paper being peeled away from a pressure sensitive adhesive layer of the patch;

FIG. 4 is an isolated perspective view showing application of the repair patch to the sleeve of the soldier uniform by placing the pressure sensitive adhesive side of the patch over the area surrounding the tear and using the concave side of a spoon-like object to apply pressure to the outer surface of the patch, thereby causing the patch to adhere to the surface of the sleeve of the uniform while covering the tear;

FIG. 5 is an exploded perspective view showing the structural layers of the repair patch of the present invention; and

FIG. 6 is a top plan view showing the repair patch contained within the moisture resistant flexible enclosure of the present invention.

Like reference numerals refer to like parts throughout the several views of the drawings.

### DETAILED DESCRIPTION OF THE PREFERRED EMBODIMENT

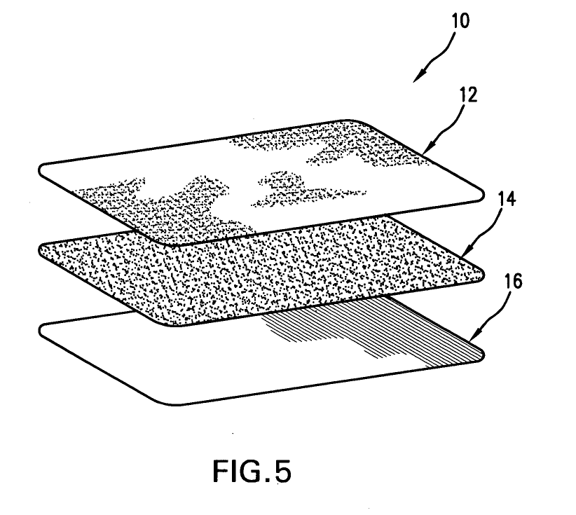

Referring initially to FIG. 5, a preferred embodiment of the repair patch of the present invention is shown and is generally indicated as 10. The repair patch includes a fabric layer 12, a pressure sensitive adhesive 14 that is laminated to the bottom side of the fabric layer 12 by hot melt lamination, and a paper release liner 16 (i.e., backing) for protectively covering the pressure sensitive adhesive prior to application. The patch 10 is die cut to the desired size and is preferably provided with radiused corners. It is contemplated that the patch will be provided in a range of sizes and is generally square or rectangular in shape, although other shapes (e.g., round) are contemplated as well. The patch is packaged, preferably in different sizes (e.g., a total of 8 patches) in a clear plastic bag/envelope with application instructions.

In a preferred embodiment, the top fabric layer 12 of the patch 10 is flame resistant and made with aromatic polyamide fibers. The repair patch of the present invention preferably uses NOMEX® IIIa fabric available from Southern Mills, Inc. of Union City, Ga. NOMEX® is a registered trademark of DuPont. The NOMEX® IIIa material is digitally printed with a camouflage pattern to match the camouflage pattern of the soldier uniform and meets or exceeds the flame retardant and NIR (near infra red) compliant standards of the soldier uniform material.

In a preferred embodiment, the pressure sensitive adhesive is SCAPA P1089™ available from Scapa North America of Windsor, Conn. SCAPA P1089™ is a flame retardant pressure sensitive adhesive that contains the following ingredients:
14%-18% Acrylic Pressure Sensitive Adhesive
1%-2% Rosin
22%-28% Halogenated Flame Retardant Compounds
37%-43% Silicone Coated (2-sides), Polyethylene Coated (2-sides) paper

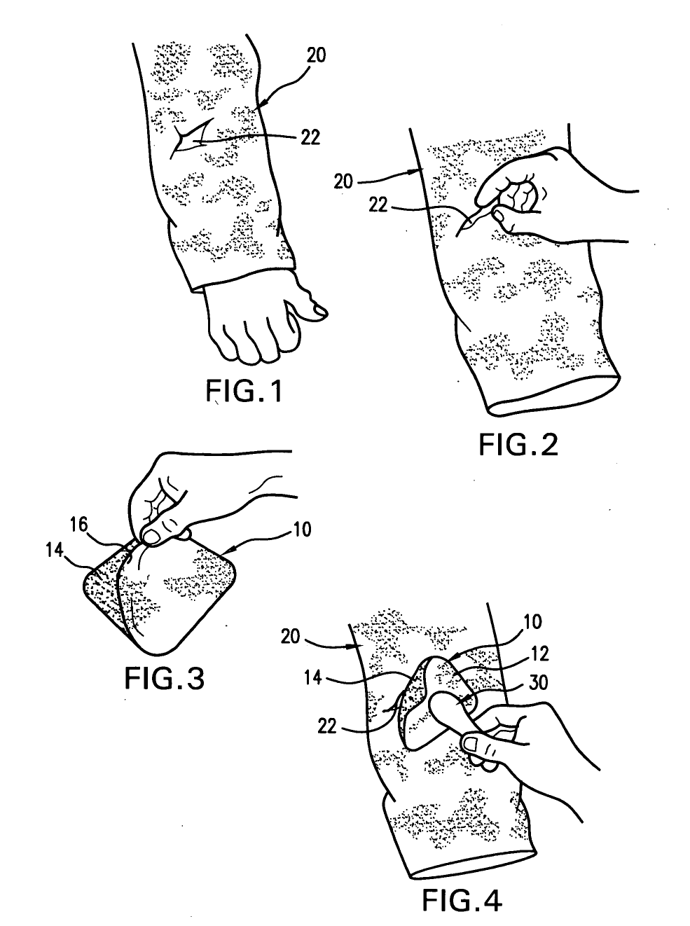

FIGS. 1-4 demonstrate the manner of attachment of the patch 10 to a soldier uniform 20 having a tear 22 in the sleeve. As seen in FIG. 1, the tear creates a significant opening in the sleeve of the uniform that exposes the soldier to potential burn injury in the event of an explosion. FIG. 2 demonstrates the manner of repairing the tear by first lying the garment on a flat, rigid surface and bringing the torn edges of the fabric together, to thereby close the opening in the sleeve. Any excess frayed materials along the torn edges should be trimmed away. The area of application should be free of dirt, sand, oil and other debris. It is preferable that the garment be laundered first, before patch application. Next, in FIG. 3, the patch 10 is prepared for attachment by first removing the peel-away backing paper to expose the pressure sensitive adhesive. Next, as seen in FIG. 4, the patch is placed over the tear, while maintaining the torn edges pulled together, and with the pressure sensitive adhesive applied directly to the outer surface of the uniform material surrounding the tear. Once positioned over the tear, the patch is pressed firmly with the fingers to smooth out wrinkles, creases or air pockets to ensure full adhesion. A spoon-like object 30 is then rubbed on the outer fabric surface of the patch in a reciprocating motion across the entire surface of the patch while applying pressure. The reciprocating motion and pressure exerted by the concave surface of the spoon-like object 30 against the patch pushes the adhesive into the fabric of the garment and generates heat and pressure to cause the pressure sensitive adhesive to fully bond with the exterior fabric of the uniform. After approximately 45 seconds of rubbing with consistent pressure, the patch will be fully adhered to the uniform, covering and maintaining the tear closed.

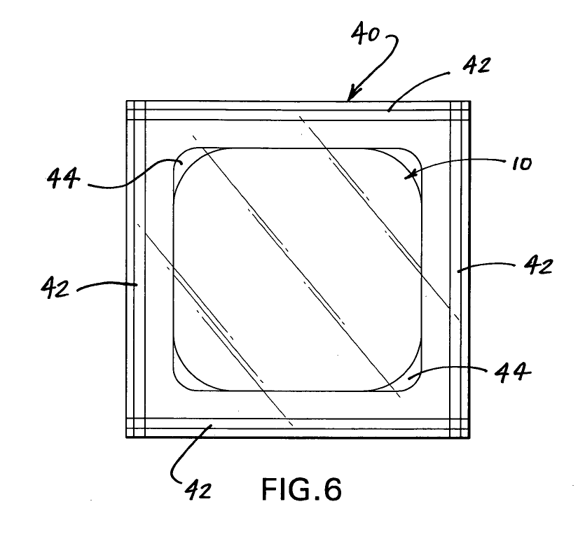

Referring to FIG. 6, a moisture resistant flexible enclosure 40 is provided for containing the patch 10. In a preferred embodiment, the moisture resistant flexible enclosure 40 is formed by two membranes of a thermoplastic urethane composition that are heat sealed together around their peripheral edges. More specifically, the two membranes of thermoplastic urethane composition are cut to the same size so that their outer peripheral edges align. With the patch sandwiched between the two membranes, the thermoplastic urethane membranes are heat sealed along seams 42 to thereby encapsulate the patch within a moisture free interior chamber 44. In a preferred embodiment, the membrane material is polybutadiene thermoplastic urethane. This polymer composition is characterized by very uniform molecular distribution and linear structure insuring maximum hydrophobic properties. The unique anionic polymerization process provides for acoustical dampening (i.e., nil sound when manipulated) and a “soft feel” texture which ensures comfort when carried within an article of clothing, such as a combat uniform. The polymer composition further provides superior flexibility and physical manipulation, even at temperatures below minus 40 degrees Fahrenheit. Moreover, the polymer composition is composed of derivative materials that provide a modicum of flame retardant properties. The polymer material composition of the flexible enclosure provides excellent chemical resistance, good low temperature properties, resistance to hydrolysis, a low moisture vapor transfer rate and outstanding electrical properties. Moreover, the enclosure 40 is inherently anti-static.

In order to determine the longevity of the patch and the flexible enclosure through numerous laundering cycles, the following experiments were performed:

Wash Test for FR Self Adhering Patch

Scope

This experiment was designed to evaluate the behavior of the repair patch on soldier uniforms when subjected to washing conditions through repeated laundering cycles.

Preparation of Samples

ACU coat and pants made out of NYCO™ material were purchased from an Army surplus store. Three inch by three inch repair patches with rounded corners (one inch radius) were used. First, the release liner was removed from the patches in order to expose the pressure sensitive adhesive. Two patches were applied on the back of the coat and one patch was applied to the elbow on the sleeve. Additionally, two patches were applied to one leg of the pant near the knee area. During application of the patches, each patch was rubbed with the back of a spoon while applying pressure and friction for approximately 45 seconds as the temperature of the patch steadily increased. This action was performed on a wooden table top.

Procedure

1. Water temperature was measured at the source (hot water faucet) with a Taylor digital thermometer, recording a reading of 130 degrees F.

2. Both samples were placed in the washing machine (Whirlpool Cabrio AGI). Arm and Hammer liquid laundry detergent was used.

3. Five fluid ounces of laundry detergent was added. Wash cycle was started with the machine settings at normal, light soil level, and hot/cold wash and rinse temperature.

4. Once the water filling phase was completed, the cycle was paused and the water temperature read inside the washing machine, with an observed reading of 116 degrees F.

5. Once the washing program ended, the samples were removed and observed.

6. Following the observations, samples were deposited in a clothes dryer at medium heat and automatic time cycle.

7. The drying cycle stopped when the dryer automatically sensed the samples were dry.

8. At the end of the drying cycle, the samples were removed and allowed to cool for two minutes.

Observations

The samples were subjected to 10 (ten) complete laundry cycles (i.e., washing and drying), after which the repair patches showed negligible separation not exceeding in any case the maximum of ⅛ of an inch around the perimeter edges of the repair patches.

### Wash Test for Moisture Resistant Flexible Enclosure Containing FR Self Adhering Patch

Scope

This experiment was designed to evaluate the behavior of FR Patch enclosure samples when subjected to washing conditions based upon 25 cycles. The average was temperature ranged from 116° F. to 132° F. with a domestic grade detergent used. The FR Patch enclosure was also subjected to total immersion in water (72 degrees F.) for 24 hours.

Preparation of Samples

Two 6.5″ squares were cut out of rubberized urethane elastomer material with inherent FR properties supplied by Brenning Specialties, Inc. to serve as base substrate.

Out of sample, a square swatch was cut of approximately 6.5″ per side of elastomer based material. The swatch was previously cured and produced in sheet (membrane) form before cutting. The FR patch (4″×4″) was applied to the center of one of the swatches of rubberized urethane elastomer with inherent FR properties material with the other swatch evenly applied over the top. Once applied, the enclosure was sealed using an impulse heat sealer. This action was performed on each of the four sides of the patch enclosure.

Out of sample, a rectangular swatch was cut of approximately 13″ in length of elastomer based material. The swatch was previously cured and produced in sheer form before cutting. The FR patch (4″×4″) was applied to the center of the swatch of rubberized urethane elastomer with inherent FR properties material with bottom half folded over the top evenly. Once applied, the enclosure was sealed using an impulse heat sealer. This action was performed on each of the three sides of the patch enclosure.

Procedure

1. Water temperature was measured at source (hot water faucet) with a Taylor digital thermometer, recording a reading of 132 F.

2. Both samples were placed in the washing machine (Whirlpool) as well as submersed in water for 24 hours.

3. Then 2.5 FL. OZ. of laundry detergent were added. (Color safe bleach alternative-contains no phosphate).

4. Wash cycle was started (see Appendix for settings).

5. Once the water filling phase was completed, the cycle was paused and the water temperature read inside the washing machine, observing a reading of 116 F.

6. Once the washing program ended the samples were removed and observed.

7. Once the observations were done, the samples were deposited in the dryer (see Appendix for settings).

8. After 6 minutes the cycle was stopped and the swatches removed.

9. Swatches were then observed and let cool down to room temperature for two minutes.

10. Next iteration of this process would start immediately.

Observations

Iteration Number 1

Samples showed perfect bond strength at the four seams. The drying process made the elastomer slightly plyable, but maintained overall material integrity through the body of the enclosure. The substrate maintained moisture barrier after 24 hr immersion in water at 72° F.

Sample 1 showed perfect bonding and sealability in all four sides. The flap intentionally created to provide an attachment flap remained intact.

Iteration Number 2

Same as first iteration.

Sample 2 showed perfect bond strength at the three seams. The drying process remained consistent. The substrate maintained moisture barrier after 24 hr immersion in water at 72° F. The only problem with folding over the material as a flap and sealing three sides was the bulge at the bottom of the enclosure that required heat sealing which added to manufacturing time.

Sample 2 showed perfect bonding in all three sides. The flap intentionally created to provide an attachment flap remained intact.

### CONCLUSION

The rubberized urethane elastomer with inherent FR properties material is able to withstand at least 25 washings under the conditions described in this document. The material also has been tested to withstand immersion (24 hrs) in water along with instron strength testing.

In one preferred embodiment, the patch 10 conforms to the following specifications:

Flame Retardant Performance: The flame propagation of the patch when applied to the base substrate shall be equal to or less than that of the original substrate. The material shall be tested in accordance with ASTM D 6413.

Spectral Reflectance: The spectral reflectance of the patch shall conform to the performance specification as stated in MIL-DTL-44436 for each pattern/style of patch: Universal Camouflage, Woodland, and Desert Patterns.

Pattern Execution: The pattern of the finished Universal Camouflage pattern patch shall reproduce the standard sample with respect to design, color, and registration of the respective areas. The pattern of the patch shall match the pattern on the specified drawing for the Universal Camouflage, 2-1-1516, 2-1-2240, and 2-1-2519.

Shade Execution: The shade of each individual color shall match the colors outlined in MIL-DTL-44436.

Matching: The color of the webbing shall match the Universal camouflage ACU standard sample (Or Woodland/Desert as applicable) when viewed under filtered tungsten lamp which approximate artificial daylight having a correlated color temperature of 75000+/−200K, with illumination of 100+/−20 foot candles, and shall be a good match to the standard sample under incandescent lamplight at 2300+/−200 K.

Adherence to substrate: The patch must remain adhered to the base substrate, on all sides (both outer and inner patches) with less than a ⅛ inch of delamination from the base substrate on all 4 sides of the patch material.

Laundering: The patch must remain adhered to the substrate as stated above after 10 home laundering washing cycles.

Physical Performance: The finished patch material shall conform to all applicable physical testing performance requirements as stated in MIL-DTL-44436, to include abrasion, weight, colorfastness, lightfastness and cracking.

While the present invention has been shown and described in accordance with a preferred and practical embodiment thereof, it is recognized that departures from the instant disclosure are contemplated within the spirit and scope of the present invention, which is not to be limited, except as defined in the following claims as interpreted under the Doctrine of Equivalents.

What is claimed is:

1. A patch kit for repairing a tear or hole in an article of clothing, comprising:
at least one patch including a sheet of fabric made from aromatic polyamide fibers, said fabric sheet having a top side and a bottom side; and a pressure sensitive adhesive composition bonded to the bottom side of said fabric sheet by heat melt lamination, and said pressure sensitive adhesive composition containing at least one flame retardant compound; and
an enclosure formed of a flexible thermoplastic urethane composition and sealed to provide a moisture resistant interior area for containing the at least one patch.

2. The patch kit as recited in claim 1 wherein the at least one patch further comprises:
a removable backing sheet for protectively covering said pressure sensitive adhesive prior to application of said patch to the article of clothing.

3. The patch kit as recited in claim 1 wherein the at least one patch, including said fabric sheet and said pressure sensitive adhesive composition, is flame retardant.

4. The patch kit as recited in claim 1 wherein the top side of said fabric sheet is colored to match the outer surface of the article of clothing.

5. The patch kit as recited in claim 1 wherein said fabric sheet is digitally printed with a color pattern appearing on the top side of said fabric sheet for matching a color pattern on the article of clothing.

6. The patch kit as recited in claim 1 wherein said fabric sheet is digitally printed with a camouflage pattern appearing on the top side of said fabric sheet for matching a camouflage pattern on the article of clothing.

7. The patch kit as recited in claim 1 wherein said fabric sheet is NOMEX® IIIa.

8. The patch kit as recited in claim 7 wherein said pressure sensitive adhesive composition is SCAPA P1089.

9. The patch kit as recited in claim 1 wherein said fabric sheet provides a spectral reflectance conforming to the performance specifications as set forth in MIL-DTL-44436.

10. A patch kit for repairing a tear or hole in an article of clothing, comprising:
at least one patch including a sheet of fabric made of a flame resistant material, said fabric sheet having a top side and a bottom side, and a pressure sensitive adhesive composition bonded to the bottom side of said fabric sheet by heat melt lamination, and said pressure sensitive adhesive composition containing at least one flame retardant compound; and
a flexible enclosure formed of a thermoplastic urethane composition and sealed to provide a moisture resistant interior area for containing the at least one patch.

11. The patch kit as recited in claim 10 wherein the at least one patch further comprises:
a removable backing sheet for protectively covering said pressure sensitive adhesive prior to application of said patch to the article of clothing.

12. The patch kit as recited in claim 10 wherein said entire patch kit, including said fabric sheet, said pressure sensitive adhesive composition, and said flexible enclosure, is flame retardant.

13. The patch kit as recited in claim 10 wherein the top side of said fabric sheet is colored to match the outer surface of the article of clothing.

14. The patch kit as recited in claim 10 wherein said fabric sheet is digitally printed with a color pattern appearing on the top side of said fabric sheet for matching a color pattern on the article of clothing.

15. The patch kit as recited in claim 6 wherein said fabric sheet is digitally printed with a camouflage pattern appearing on the top side of said fabric sheet for matching a camouflage pattern on the article of clothing.

16. A patch kit for repairing a tear or hole in an article of clothing, comprising:
at least one patch including a sheet of fabric having a top side and a bottom side, and a pressure sensitive adhesive composition bonded to the bottom side of said fabric sheet by heat melt lamination, and said pressure sensitive adhesive composition containing at least one flame retardant compound; and
a flexible enclosure formed of a thermoplastic urethane composition and sealed to provide a moisture resistant interior area for containing the at least one patch therein.
